(19) United States
(12) Patent Application Publication
(10) Pub. No.: US 2010/0053231 A1
(43) Pub. Date: Mar. 4, 2010

(54) DISPLAY APPARATUS HAVING VARIOUS SHAPE

(75) Inventor: Woon Yong Park, Suwon (KR)

Correspondence Address: Muncy, Geissler, Olds & Lowe, PLLC, P.O. BOX 1364, FAIRFAX, VA, 22038-1364, US

(73) Assignee: TOVIS CO., LTD, Wonju-city (KR)

(21) Appl. No.: 12/516,201

(22) PCT Filed: Nov. 23, 2006
(86) PCT No.: PCT/KR06/04939

§ 371 Date: May 25, 2009

(51) Int. Cl. G09G 5/10; G09G 5/00

(52) U.S. Cl. 345/690; 345/204

(57) ABSTRACT

Disclosed relates to a display device including: a display unit displaying an image and formed such that interior angles that outer frames thereof make have values smaller or larger than 90°, and a driving unit driving the display unit by supplying image and character information to the display unit. Moreover, the display device is applicable to a game device including: a main body; a monitor included in the main body and displaying a game screen; and a display unit included in the main body and displaying an image, in which outer frames thereof selectively make a circular shape, a semicircular shape, or a shape mixed with a straight line and a curved line. The display device has an advantageous effect in that the display unit is designed with various shapes such as a semicircle and the like, thus polishing the appearance and providing a variety of designs.

### TECHNICAL FIELD

The present invention relates to a display device and, more particularly, to a display device of various shapes such as a circle, and the like, that displays character or image information and is applicable to a game device to serve an advertisement purpose.

### BACKGROUND ART

In general, a display device is a device that displays image or character information on a screen thereof so that a user recognizes such information.

Such display devices including a cathode ray tube (CRT), a liquid crystal display (LCD), a plasma display panel (PDP), an organic electroluminescence (EL), etc. have been developed variously, and they may be selectively used according to the use purpose or the preference.

The display device generally comprises a display main body 1 having a rectangular shape and a screen 2 included in the display main body 1 as depicted in FIG. 1.

Accordingly, as the image or character information is displayed on the screen 2, the display device may be appropriately used as a television set, a computer monitor, an advertising board, etc. according to the use purpose.

However, such a display device having a rectangular screen has a problem in that it has considerable limitations in terms of design.

That is, the display device having a rectangular screen has a problem in that it cannot ensure a variety of designs for commercial or industrial purposes.

### DISCLOSURE OF INVENTION

### Technical Problem

The present invention has been made in an effort to solve the above-described problems, and an object of the present invention is to provide a display device in which a display unit is configured in various shapes such as a semicircle and the like to ensure a variety of designs, and a game device using the same.

Moreover, another object of the present invention is to provide a display device that is suitably applicable to a game player, a slot machine, or a casino machine for a reel game, and the like, by designing the display unit with various shapes, and a game device using the same.

### TECHNICAL SOLUTION

To accomplish the object of the present invention, there is provided a display device comprising: a display unit displaying an image and formed such that interior angles that outer frames thereof make have values smaller or larger than 90°; and a driving unit driving the display unit by supplying image and character information to the display unit.

Moreover, the present invention provides a game device comprising: a main body; a monitor included in the main body and displaying a game screen; and a display unit included in the main body and displaying an image, in which interior angles that outer frames thereof make have values smaller or larger than 90° or the outer frames selectively make a circular shape, a semicircular shape, or a shape mixed with a straight line and a curved line.

### ADVANTAGEOUS EFFECTS

According to the present invention, the display unit is designed with various shapes such as a semicircle and the like, thus polishing the appearance and providing a variety of designs.

Moreover, the display unit designed with various shapes in accordance with the present invention provides advantageous effects in that it is suitably applicable to a game player, a slot machine, or a casino machine for a reel game, and the like, and thereby it is appropriately used as an advertising board, a bulletin board, an image medium, and the like.

### BRIEF DESCRIPTION OF THE DRAWINGS

FIG. 1 is a perspective view depicting an LCD device in accordance with a conventional art;

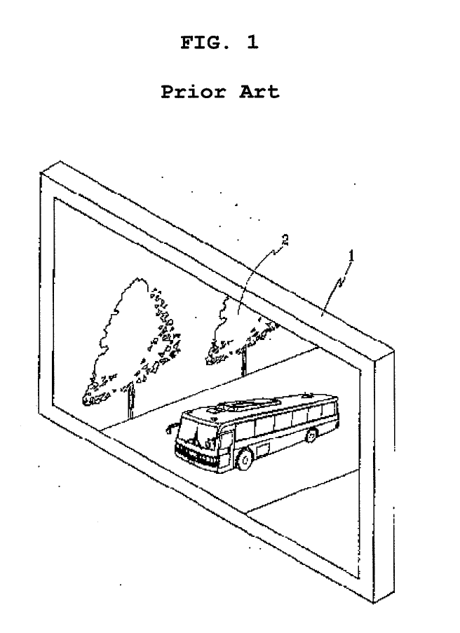

FIG. 2 is a perspective view depicting a semicircular display device in accordance with a preferred embodiment of the present invention;

FIG. 3 is an exploded perspective view depicting an internal structure of the semicircular display device in FIG. 2;

FIG. 4 is a perspective view depicting a display device in accordance with another embodiment of the present invention; and

FIG. 5 is a front view showing an example of a game device, to which a display device in accordance with the present invention is applied to.

### BEST MODE FOR CARRYING OUT THE INVENTION

The present invention provides a display device and a game device using the same. The present invention may be embodied by a display device comprising: a display unit displaying an image and formed such that interior angles that outer frames thereof make have values smaller or larger than 90°; and a driving unit driving the display unit by supplying image and character information to the display unit, and by a game device using the display device comprising: a main body; a monitor included in the main body and displaying a game screen; and a display unit included in the main body and displaying an image, in which interior angles that outer frames thereof make have values smaller or larger than 90° or the outer frames selectively make a circular shape, a semicircular shape, or a shape mixed with a straight line and a curved line.

### MODE FOR THE INVENTION

Hereinafter, the present invention will now be described more fully with reference to the accompanying drawings, in which preferred embodiments of the invention are shown.

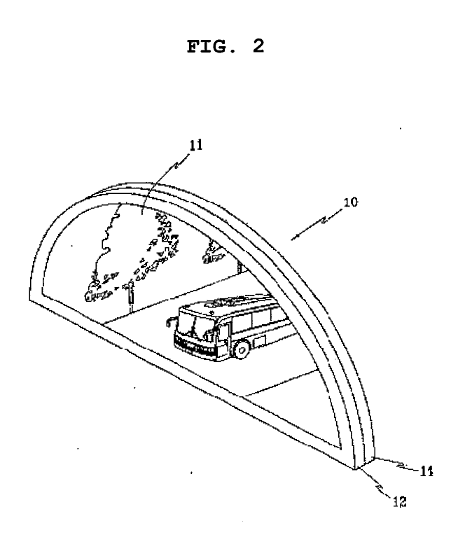

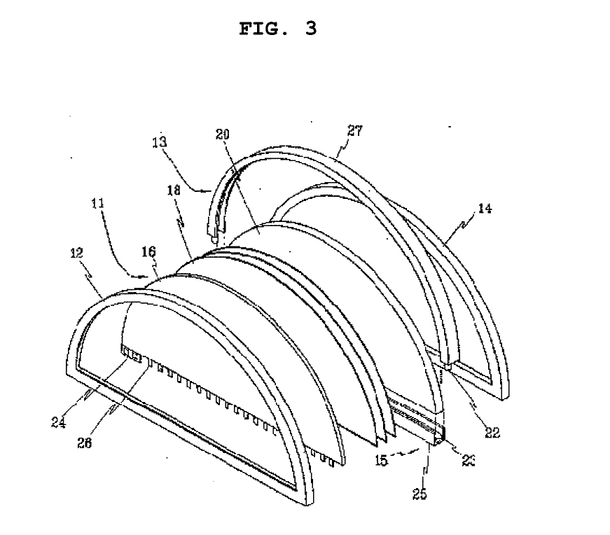

As depicted in FIGS. 2 and 3, a display device 1 that the present invention proposes may be formed in various shapes such as a semicircle, a pentagon, a circle, etc. other than a rectangular shape of conventional displays in the same manner, and the display device having a semicircular shape will be described as an example in the following preferred embodiments.

The display device 1 comprises a display unit 11 displaying an image and formed such that interior angles that outer frames make have values smaller or larger than 90°, and a driving unit 13 driving the display unit 11 by supplying image and character information to the display unit 11.

Here, the outer frames denote a curved line and a straight line that make a front frame 12 (see FIG. 3), and the interior angles denote angles that the curved line and the straight line make.

The display unit 11 comprises front and rear frames 12 and 14, and a display panel 16 included in the front and rear frames 12 and 14 and displaying an image.

Here, the display panel 16 may preferably include a liquid crystal display (LCD) and selectively include a plasma display panel (PDP), an organic electroluminescence (EL), a cathode ray tube (CRT), an electronic paper display (EPD), and the like.

Since the display panel 16 and the driving unit 13 provided therein have various shapes such as a semicircle, a pentagon, a circle, etc. other than the rectangular shape, the front and rear frames 12 and 14 have the same shapes as the display panel 15 and the driving unit 13.

The display panel 16 having a semicircular shape displays a desired image by supplying an electric power to a liquid crystal layer.

The driving unit 13 includes a substrate 24 provided on one side of the display panel 16 and applying a driving signal to the display panel 16, a driving IC package 26 including a gate driving IC package and a data driving IC package and arranged on the display panel 16 to supply information, and a backlight assembly 15 supplying light to the display panel 16.

The substrate 25 is provided on one side of the display panel 16 and has a driving circuit therein to apply a driving signal to the display panel 16. The driving IC package 26 including the gate driving IC package and the data driving IC package is arranged along the one side of the display panel 16.

Here, the substrate 24 and the driving IC package 26 may be suitably arranged on the lower circumference of the display panel 16.

Accordingly, a desired image can be displayed on the display panel 16 by the driving signal applied from the substrate 24.

Meanwhile, the backlight assembly 15 includes light sources 22 and 24 supplying light, covers 25 and 27 covering the light sources 22 and 24, a light guide plate 20 ensuring luminance characteristics of the light from the light sources 22 and 23 and guiding the light to the display panel 16, and an optical sheet 18 ensuring the luminance characteristics of the light from the light sources 22 and 23 and supplying the light to the display panel 16.

The structure of the backlight assembly 15 may be suitably changed to have a semicircular shape. That is, in case of the light sources 22 and 23, a fluorescent lamp 23 arranged in the lower portion thereof has a rectilinear shape and a fluorescent lamp 22 arranged in the upper portion thereof has a semicircular shape. Of course, the cover 27 covering the outside of the light sources 22 and 23 has a semicircular shape.

Accordingly, it is possible to suitably apply the light sources 22 and 23 having a semicircular shape to the backlight assembly 15.

Moreover, the light guide plate 20 and the optical sheet 18 also have a semicircular shape to correspond to the display panel 16.

As a result, the light emitted from the light source 22 and 23 passes through the light guide plate 20 and the optical sheet 18 to be irradiated on the display panel 16.

As above, although the description has been made, by way of an example, in which the lamps are exemplified as the light sources 22 and 23, the present invention is not limited thereto, but it is possible to use a light emitting diode LED instead of the lamp and to use a line light source or a surface light source.

Like this, by designing the display device with a semicircular shape, it is possible to polish the appearance compared with the conventional display having a rectangular shape and to provide a variety of designs.

The display device may be fabricated in various shapes such as a pentagon, a circle, etc. other than the semicircular shape as described above.

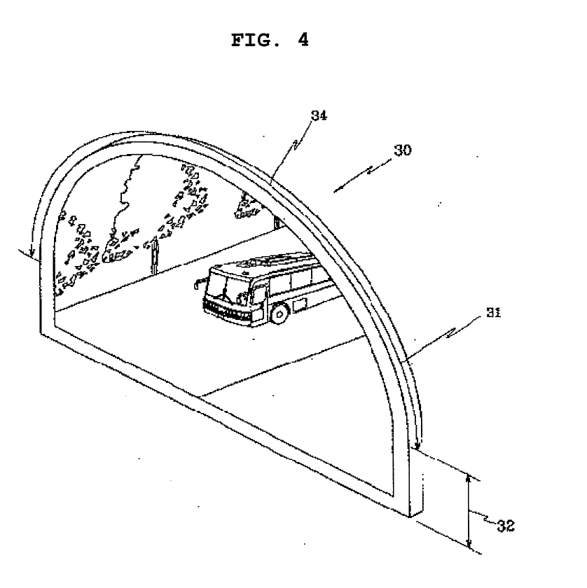

Another example of the display device having another shape is depicted in FIG. 4.

That is, FIG. 4 depicts a display device having a shape in which a semicircle extends downward.

In more detail, the display device 30 in the figure comprises a rectilinear portion 32 formed with a predetermined height and a curved portion 31 formed between the rectilinear portions 32.

Accordingly, the front and rear frames 34 and the backlight assembly including the light guide plate, optical sheet, lamp, etc. of the display device 30 have shapes including the rectilinear portions and the curved portion.

As above, although the description has been made, by way of an example, in which the LCD is exemplified as the display device, the present invention is not limited thereto, but it may include the other display media, such as a plasma display panel (PDP), a projection, an organic electroluminescence (EL), and the like.

Meanwhile, while the display device may be applied to various fields such as a television set, a computer monitor, etc., preferably, it is applied to a game player, i.e., a casino machine.

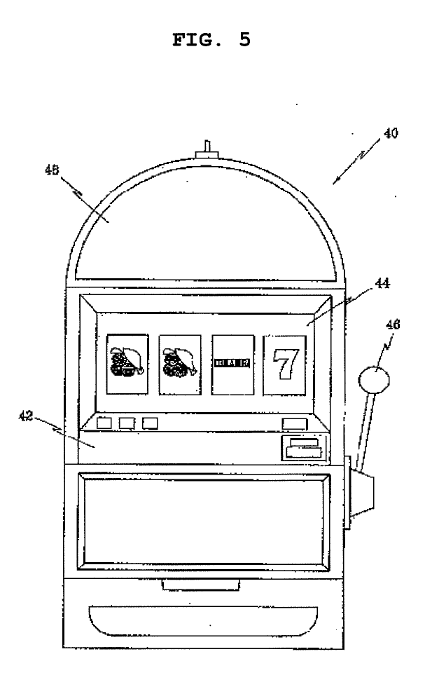

That is, as depicted in FIG. 5, a semicircular display device that the present invention proposes is provided in the upper portion of a casino machine.

Accordingly, it is possible to display various images on the semicircular display device and thereby it may be used as an advertising board, a bulletin board, and the like.

In more detail, the casino machine 40 comprises a main body 42, a monitor 44 included in the main body 42 and displaying a casino game screen, a handle 46 for playing a game, and a display unit 48 included in the upper portion of the main body 42 and displaying an image.

Such a casino machine 40 denotes a machine widely known in the art.

That is, the game starts by pulling the handle 46 of the casino machine 40, and a user may gain points or game money by the combination of pictures or symbols displayed on the monitor 44.

During the game, it is possible to display an advertisement, a report or information, a television program, and the like through the display unit 48.

Accordingly, the display unit 48 may be suitably used as an advertising board, a bulletin board, a TV set, and the like.

Of course, the display unit 48 is not limited to an LCD, but may be a plasma display panel (PDP), an organic electroluminescence (EL), a projection, and the like.

Moreover, the display unit 48 may be formed with various shapes such as a triangle, a pentagon, a lozenge, a circle, etc. as well as the semicircular shape.

Furthermore, it is possible to display information related to the game on the display unit 48.

### INDUSTRIAL APPLICABILITY

According to the present invention, the display unit designed with various shapes provides advantageous effects in that it is suitably applicable to a game player, a slot machine, or a casino machine for a reel game, and the like, and thereby it is appropriately used as an advertising board, a bulletin board, an image medium, and the like. Accordingly, it is possible to provide a variety of information through the display device applied to the casino machine to related companies and users.

1. A display device comprising:
a display unit displaying an image and formed such that interior angles that outer frames thereof make have values smaller or larger than 90°; and
a driving unit driving the display unit by supplying image and character information to the display unit.

2. A display device comprising:
a display device displaying an image, in which outer frames thereof selectively make a circular shape, a semicircular shape, or a shape mixed with a straight line and a curved line; and
a driving unit driving the display unit by supplying image and character information to the display unit.

3. The display device as recited in claim 1
wherein the display unit comprises front and rear frames, and a display panel included in the front and rear frames and displaying an image, the display panel being driven in a liquid crystal display method.

4. The display device as recited in claim 3,
wherein the driving unit comprises a substrate provided on one side of the display panel and applying a driving signal to the display panel, a driving IC package including a gate driving IC package and a data driving IC package and arranged on the display panel to supply information, and a backlight assembly supplying light to the display panel.

5. The display device as recited in claim 4,
wherein the backlight assembly comprises a light source supplying light, a cover covering the light source, a light guide plate guiding the light emitted from the light source to the display panel, and an optical sheet ensuring luminance characteristics of the light from the light source and supplying the light to the display panel.

6. The display device as recited in claim 5,
wherein the light source, the cover, the light guide plate and the optical sheet have the same shape as the display panel.

7. The display device as recited in claim 1,
wherein the display unit and the driving unit include at least one selected from the group consisting of a plasma display panel (PDP), an organic electroluminescence (EL) display, a cathode ray tube (CRT) and an electronic paper display (EPD).

8. The display device as recited in claim 1,
wherein the display unit has a shape selected from the group consisting of a triangle, a pentagon, and a lozenge such that the interior angles that the outer frames make have values smaller or larger than 90°.

9. A game device comprising:
a main body;
a monitor included in the main body and displaying a game screen; and
a display unit included in the main body and displaying an image, in which interior angles that outer frames thereof make have values smaller or larger than 90° or the outer frames selectively make a circular shape, a semicircular shape, or a shape mixed with a straight line and a curved line.

10. The game device as recited in claim 9,
wherein the display unit comprises front and rear frames, a display panel included in the front and rear frames and displaying an image, a substrate provided on one side of the display panel and applying a driving signal to the display panel, a driving IC package including a gate driving IC package and a data driving IC package and arranged on the display panel to supply information, and a backlight assembly supplying light to the display panel.

11. The game device as recited in claim 10,
wherein the backlight assembly comprises a light source supplying light, a cover covering the light source, a light guide plate guiding the light emitted from the light source to the display panel, and an optical sheet ensuring luminance characteristics of the light from the light source and supplying the light to the display panel.

12. The game device as recited in claim 9,
wherein a handle for starting a game is included on one side of the main body and a casino game screen is displayed on the monitor so as to play a casino game.

13. The game device as recited in claim 9,
wherein the display unit includes at least one selected from the group consisting of a plasma display panel (PDP), an organic electroluminescence (EL) display, a cathode ray tube (CRT), an electronic paper display (EPD), and a liquid crystal display (LCD).

14. The game device as recited in claim 9,
wherein the display unit has a shape selected from the group consisting of a triangle, a pentagon, and a lozenge.

15. The game device as recited in claim 9,
wherein the display unit displays information and screen related to the game.

16. The display device as recited in claim 2,
wherein the display unit comprises front and rear frames, and a display panel included in the front and rear frames and displaying an image, the display panel being driven in a liquid crystal display method.

17. The display device as recited in claim 16,
wherein the driving unit comprises a substrate provided on one side of the display panel and applying a driving signal to the display panel, a driving IC package including a gate driving IC package and a data driving IC package and arranged on the display panel to supply information, and a backlight assembly supplying light to the display panel.

18. The display device as recited in claim 17,
wherein the backlight assembly comprises a light source supplying light, a cover covering the light source, a light guide plate guiding the light emitted from the light source to the display panel, and an optical sheet ensuring luminance characteristics of the light from the light source and supplying the light to the display panel.

19. The display device as recited in claim 18,
wherein the light source, the cover, the light guide plate and the optical sheet have the same shape as the display panel.

20. The display device as recited in claim 2,
wherein the display unit and the driving unit include at least one selected from the group consisting of a plasma display panel (PDP), an organic electroluminescence (EL) display, a cathode ray tube (CRT) and an electronic paper display (EPD).
